(19) United States
(12) Patent Application Publication
(10) Pub. No.: US 2011/0241509 A1
(43) Pub. Date: Oct. 6, 2011

(54) APPARATUS FOR DRIVING AN ACTUATING MECHANISM, OPENING APPARATUS, AND PIECE OF FURNITURE

(75) Inventors: Jürgen AHLFELD, Weissensberg (DE); Jörg Janzen, Feldkirch (AT)

(73) Assignee: Grass GmbH, Hochst (AT)

(21) Appl. No.: 13/159,703

(22) Filed: Jun. 14, 2011

Related U.S. Application Data
(63) Continuation of application No. PCT/EP2009/007829, filed on Nov. 2, 2009.

(30) Foreign Application Priority Data
Dec. 15, 2008 (DE) 20 2008 016 466.4

(51) Int. Cl. A47B 96/00; F16H 35/00; F16H 7/02; F16H 7/06; F16H 7/08

(52) U.S. Cl. 312/294; 74/640; 474/148; 474/84; 474/101

(57) ABSTRACT

An apparatus for driving an actuating mechanism, of an apparatus for opening and/or closing a furniture part accommodated in a movable manner on a basic furniture part, including a drive unit for driving the actuating mechanism via a transmission arrangement with a plurality of transmission members. The actuating mechanism is arranged on one of the furniture parts and can be brought temporarily into contact with the other furniture part during opening and/or closing. The contact between the actuating mechanism and the other furniture part is broken during an opening operation. The transmission arrangement includes a traction-mechanism device.

### CROSS REFERENCE TO RELATED APPLICATIONS

This application is a continuation of International Application No. PCT/EP2009/007829 filed Nov. 2, 2009, which designated the United States, and claims the benefit under 35 USC §119(a)-(d) of German Application No. 20 2008 016 466.4 filed Dec. 15, 2008, the entireties of which are incorporated herein by reference.

### FIELD OF THE INVENTION

The invention relates to an apparatus for driving an actuating mechanism, to an opening apparatus, and to a piece of furniture.

### BACKGROUND OF THE INVENTION

Arrangements for driving an actuating mechanism of an apparatus for opening and/or closing a furniture part accommodated in a movable manner on a basic furniture part are known. For example, displaceable or pivotable furniture parts such as drawers, doors, shutters or the like, use can be made of opening apparatuses with an opening mechanism which can be actuated by an electric motor. Opening can take place over part of a possible opening distance, or over the entire possible opening distance, under the action of the opening mechanism, which includes pushing-out devices.

The drive unit can drive, for example, an actuating mechanism, for example a pushing-out device. In this case, following a triggering command by a user, a movable furniture part is moved or pushed out of a rest position or closed position in the basic furniture structure. The drive unit comprises, for example, an electric, pneumatic and/or hydraulic drive. In order to transmit driving action from the drive to the actuating mechanism, a transmission unit may be active between these elements. The transmission unit may be in a number of parts or stages, in order to take account, for example, spatial conditions and/or to realize a desired step-down or step-up transmission ratio from the drive to the actuating mechanism.

Such systems are still in need of improvement in particular in respect of undesired side effects, e.g. the development of noise and wear.

### SUMMARY OF THE INVENTION

It is an object of the present invention to improve known arrangements for driving an actuating mechanism of an opening and/or closing apparatus, in particular in respect of undesirably high levels of noise and/or wear during operation.

The invention proceeds, in the first instance, from an apparatus for driving an actuating mechanism of an apparatus for opening and/or closing a furniture part accommodated in a movable manner on a basic furniture part, comprising a drive unit, which can drive the actuating mechanism via a transmission arrangement with a plurality of transmission members, and the actuating mechanism can be arranged on one of the furniture parts and can be brought temporarily into contact with the other furniture part during opening and/or closing, wherein the contact between the actuating mechanism and the other furniture part is broken during an opening operation. During a closing operation, the contact between the actuating mechanism and the other furniture part can be established for the first time over a final portion of the retraction path, or the contact is permanent. In particular, the invention relates to an apparatus for driving a pushing-out mechanism of an arrangement for pushing out a movable furniture part.

The drive unit is, in particular, a motor-driven drive unit, for example an electric motor.

A significant aspect of the invention resides in the fact that the transmission arrangement comprises a traction-mechanism device. The traction-mechanism device comprises, for example, a traction-mechanism drive which can transmit a torque between two shafts with the aid of a traction mechanism which wraps around two shaft ends. The two shafts are not in contact here, wherein the traction-mechanism device allows both force-fitting drive transmission and form-fitting drive transmission between transmission members.

The traction-mechanism device makes it possible for undesired noise to be avoided, or at least vastly reduced in relation to prior-art arrangements, during operation of the opening and/or closing apparatus by the drive unit.

The traction-mechanism device advantageously comprises a belt-drive device with a drive belt and/or a chain-drive device with a chain drive for transmitting rotary movement between two rotatable transmission members. These can provide the necessary forces and/or moments for, for example, rotary transmission with only a low level of slippage, if any at all. Low-noise driving can be provided in particular in the case of a belt-drive device with a drive belt. Moreover, a belt-drive device makes it possible to realize a straightforward and compact construction and a low overall height for the transmission arrangement. In particular this provides an advantageous alternative to worm drives which are known per se or to normal toothed transmissions. Moreover, it is advantageously possible, via the belt-drive device, for a region between the transmission members interacting with the belt to remain free or to be utilized in some other way.

Suitable drive belts include a wide variety of different belt-like traction mechanism or types and shapes of belts, in particular flat belts, round belt or V-belts. Toothed belts can be used particularly advantageously. A drive belt may be constructed from one or more parts.

It is also advantageous if the drive belt of the belt-drive device transmits driving action between one transmission member, which is accommodated on a rotary shaft of the drive unit, and a further transmission member. This makes it possible, in a particularly effective manner, to minimize or avoid undesired running noise or driving noise as the actuating mechanism is being driven.

It is particularly advantageous if the belt-drive device comprises a plurality of drive belts. The aforementioned advantages can thus be increased further. If appropriate, it is possible for all or most of the transmission members present to be driven via a drive belt and/or at least two, or possibly all, can use a drive belt to drive a downstream transmission member. A drive belt can serve, for example, for driving a transmission member, wherein this transmission member can drive a downstream transmission member likewise via a drive belt or in some other way, for example, by way of intermeshing pinions.

The at least one drive belt can act between any two of the plurality of transmission members, in order to achieve the advantages mentioned. The drive belt can act in a first portion of the drive train, this first portion following the drive, and/or in a region of the transmission arrangement which is spaced apart from the drive via at least one intermediate transmission member. It is basically possible to have any desired combination of the drive-belt arrangement with other transmission mechanisms within a transmission arrangement.

Moreover, it is particularly advantageous if the belt-drive device comprises two drive belts, wherein a first drive belt acts between a first transmission member and a second transmission member and a second drive belt acts between the second transmission member or a further transmission member and a third transmission member. It is thus possible to minimize noise in particular in a region of the transmission arrangement which is particularly sensitive in respect of noise development. This is because it is possible, for example in the case of transmission members designed as pinions, for relatively high levels of running noise to occur in particular in the first stages of the transmission arrangement, these stages following the drive unit. The second drive belts can act, for example, between the transmission member driven by the first drive belt and a further, third transmission member, or it may be active between a transmission member other than the second one and a further, other transmission member.

It is particularly advantageous to provide a tensioning mechanism which can be used to set the tensioning of a drive belt of the belt-drive device. It is thus possible for an undesired level of play or slippage between a belt and at least one transmission member to be reduced to a desired or acceptable level. Moreover, it is thus possible to readjust excessively low belt tensioning which is otherwise established, if not readjusted, over the service life of the transmission arrangement. This can be done by a constantly active retensioning mechanism or by a retensioning mechanism that can be activated from time to time.

The tensioning mechanism advantageously comprise an adjusting arrangement for adjusting a position of the drive unit, wherein the drive unit is mounted in a movable manner. The drive unit may be accommodated, for example, with firmly predetermined positioning, but such that it can be moved along an adjusting path, wherein the adjusting path allows only a comparatively small amount of movement in two opposite directions, for example, in the two-digit millimeter range. It is thus a straightforward matter to re-tension a drive belt which is accommodated on the drive unit or on a transmission member which is accommodated on a rotary shaft of the drive unit.

The adjusting arrangement preferably comprises a resilient mount for mounting the drive unit in a resilient manner. The tensioning of a drive belt of the belt-drive arrangement is achieved here by the resilient mounting of the entire drive unit, for example, of a motor. In particular, belt pretensioning is thus realized automatically, or with self-regulating action, by the corresponding resilientmount. Possibly briefly occurring forces which act on the belt tensioning in the transmission arrangement can thereby also be easily absorbed and/or deflected. The invention makes it possible to avoid, in these cases, damage to parts of the drive unit and/or of the transmission arrangement which otherwise cannot be ruled out. The drive-belt tensioning can be realized via the positioning of the drive unit, which under the action of the resilient mount has an amount of play, or can be shifted, in two opposite directions.

In an advantageous modification of the subject matter of the invention, the resilient mount comprise a resilient plate which is supported on fixed portions and on the movably mounted drive unit. The support of the resilient plate on the drive unit can take place directly or indirectly, in the latter case for example on a portion which is coupled or connected to the drive unit. The resilient plate, which is subjected to prestressing, in particular in the inserted state, pushes against the drive unit and forces the latter into a position in which enhanced and/or permanent belt tensioning is achieved. Resilient mounting of the drive unit can thus be realized in a straightforward and compact manner.

Moreover, it is advantageous if the resilient mount comprises a pin element with a resiliently disengageable pin portion in order to push the drive unit into a tensioning position, in particular the pin element can be set in its position relative to the movably mounted drive unit. A resiliently disengageable pin portion requires only a comparatively very small amount of installation space.

A further significant aspect of the invention relates to an opening apparatus for pushing out a furniture part accommodated in a movable manner on a basic furniture part, comprising a drive unit, which can drive a pushing-out mechanism via a transmission arrangement with a plurality of transmission members, and the pushing-out mechanism can be arranged on one of the furniture parts and can be brought temporarily into contact with the other furniture part during the pushing-out movement, wherein the contact between the pushing-out mechanism and the other furniture part is broken during a pushing-out operation. According to the invention, such an opening apparatus is provided with one of the above-described apparatuses for driving an actuating mechanism. The corresponding advantages presented can thus be achieved for an opening apparatus.

The invention also relates to a piece of furniture with a basic furniture part on which a furniture part is accommodated in a movable manner, wherein an opening apparatus like that mentioned above is present. The piece of furniture may thus be equipped advantageously in respect of advantageous opening and/or closure of the movable furniture part.

### BRIEF DESCRIPTION OF THE DRAWINGS

Further features and advantages of the invention will be explained in more detail with reference to an exemplary embodiment according to the invention.

FIG. 1 shows a perspective view of a pushing-out apparatus with the front housing part removed and having an apparatus according to the invention for driving an actuating mechanism;

FIG. 2 shows an enlarged detail of the arrangement according to FIG. 1,

FIG. 3 shows a detail of the arrangement according to FIG. 1 as seen in a view which has been rotated through 180 degrees, and

FIG. 4 shows a plan view of a detail of the arrangement according to FIG. 3.

### DETAILED DESCRIPTION OF THE INVENTION

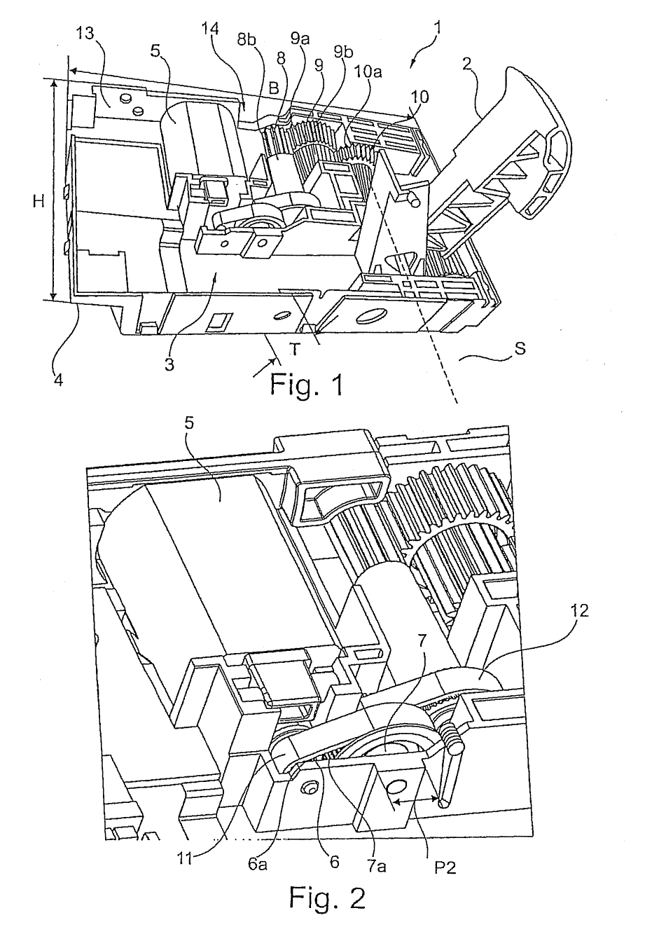

The figures illustrate a pushing-out unit 1 with a pushing-out mechanism designed as a pivotable pushing-out lever 2, wherein a housing covering of the pushing-out unit 1 is absent. FIG. 1 shows the pushing-out lever 2 in its position in which it has been pivoted to the maximum extent about a pivot axis S in relation to a fully pivoted-in position. In the fully pivoted-in (not illustrated) position of the pushing-out lever 2, the latter is accommodated entirely in an accommodating depression 3 of the pushing-out unit 1, in particular beneath a front side of the pushing-out unit 1, this front side being formed by the housing covering (not illustrated). The pushing-out lever 2 can be pivoted, for example, through approximately 120 degrees at most.

The pushing-out unit 1 has a housing 4 formed, for example, from a plastic material, wherein the pushing-out unit 1 is more or less cuboidal. With a component depth T for example in the range of from 1 to 3 cm, the pushing-out unit 1 can be fitted in a space-saving manner in the region of a rear wall of a basic furniture structure, wherein the front side with the pivotable pushing-out lever 2 is directed toward a rear side of a movable furniture part which is to be pushed out. By acting on a rear wall for example of a drawer, which is accommodated in a displaceable manner in the basic furniture structure, a pivoting-out movement of the pushing-out lever 2 can cause the pushed-in drawer to be pushed out.

A component width B of the pushing-out unit may be, for example, in the range of from 5 to 10 cm, and a component height H may be approximately 5 cm.

The pushing-out lever 2 is pivoted via an electric motor 5. A drive shaft of the electric motor 5, in the exemplary embodiment shown, is parallel to laterally running outer edges of those sides of the pushing-out unit 1 which form the height dimensions H. The drive shaft of the electric motor 5 has present on it a first transmission member 6 (FIG. 2), which, like the further transmission members 7 to 10 as well, is designed as a gearwheel or a rotatably mounted pinion. The transmission members 6 to 10 are designed appropriately, and/or coordinated individually with one another, for realizing a desired step-up or step-down transmission ratio, and this is manifested by the respective diameters of the toothing-formation profiles.

The transmission members 7 to 10 are each provided with two toothing-formation portions having different diameters in relation to the common axis of rotation. For each transmission member 7 to 10 in the direction of the drive train from the electric motor 5 to the pushing-out lever 2, that is to say from a drive side to an output side, the diameter of the toothing-formation portion on the drive side is greater than that on the output side. The pushing-out lever 2 pivots about the pivot axis S by virtue of a driving action of the transmission member 10 which is the last to act in the drive train. The pushing-out lever 2 is pivoted by the rotation of the transmission member 10.

The drive transmission from the first transmission member 6 on the rotary shaft of the electric motor 5 to the second transmission member 7 takes place via a first toothed belt 11, which engages with rotation-transmitting action in a matching toothing-formation portion 6a of the transmission member 6 and in a matching toothing-formation portion 7a of the transmission member 7. With the electric motor 5 running, the transmission member 6 is thus driven and the transmission member 7 is made to rotate via the toothed belt 11. The rotational speed of the transmission member 7 is determined by the rotational speed of the transmission member 6 and the ratio of the diameters of the toothing-formation portions 6a and 7a, that is to say it is stepped down here, and therefore the transmission member 7 rotates at a lower rotational speed than the transmission member 6. At the second transmission member 7, a further toothed belt 12 engages in a toothing-formation portion 7b (see FIG. 4), which is concealed by the toothed belt, for transmitting rotation to the third transmission member 8. For this purpose, the transmission member 7 has formed on it a further toothing-formation portion 7b, which has a diameter smaller than the diameter of the toothing-formation portion 7a. The toothed belt 12 drives the transmission member 8 and wraps around a toothing-formation portion 8a (see FIG. 4) for this purpose. The two toothed belts 11 and 12 are located parallel alongside one another and have a common eyelet, the center of which is determined by the axis of rotation of the transmission member 7.

The toothed belt 12 thus wraps around the toothing-formation portion 7b, of which the diameter is smaller than the diameter of the toothing-formation portion 8a of the transmission member 8, this portion 8a likewise having the toothed belt 12 wrapped around it. The transmission member 9 is driven via a diameter of a further toothing-formation portion 8b of the transmission member 8, this diameter being smaller than the diameter of the toothing-formation portion 8a. This takes place by meshing engagement between the toothing-formation portion 8b and the toothing-formation portion 9a of the transmission member 9. The transmission member 10 is driven via a toothing-formation portion 9b, of which the diameter is reduced in relation to the diameter of the toothing-formation portion 9a, wherein the toothing-formation portion 9b meshes with a toothing-formation portion 10a of the transmission member 10. The final transmission member 10 is thus made to rotate by the electric motor 5, via the multi-stage transmission arrangement, and the pushing-out lever 2 is thus driven to pivot. By reversing the direction of rotation via the correspondingly switched-over electric motor 5, and by means of the transmission members 6 to 10, the pushing-out lever 2 is pivoted back in the opposite pivoting direction.

A printed circuit board 13 placed adjacent to the electric motor 5 is used for the electrical and/or control-related connection of the electric motor 5, and thus of the pushing-out unit 1.

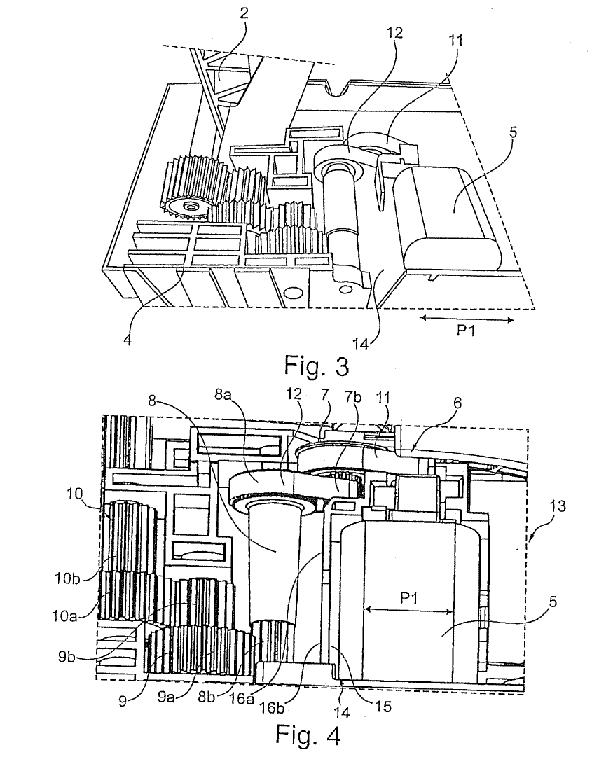

A belt-tensioning device 14 with spring-loaded mounting for the electric motor 5 is provided for automatic belt tensioning of the toothed belts 11 and 12. For this purpose, a merely slightly angled resilient plate 15 is clamped in between wall portions 16a and 16b with end-side abutment in each case and, in the region of inflection, with abutment against a housing of the electric motor 5. The electric motor 5 is mounted such that it can be displaced in the direction of double arrow Pb (see FIGS. 3 and 4) along a base region of the housing 4. It is likewise the case that the transmission member 7, or the axis of rotation thereof, can be displaced to some extent in the direction of double arrow P2 (see FIG. 2). The possible displacement paths in the directions of arrows P1 and P2 are, in particular, in the millimeter range. The prestressing of the resilient plate 15 thus makes it possible for the electric motor to be pushed away from the side of the transmission members 6 to 10 such that sufficiently high belt tensioning of the toothed belts 11 and 12 is always ensured. For this purpose, the axis of rotation of the transmission member 12 is fixed in position. Depending on the arrangement and/or selection of the resilient plate 15, a desired level of belt pretensioning can be realized with the belt-tensioning device 14. Reliable drive transmission from the transmission member 6 to the transmission member 7, and from the latter to the transmission member 8, can always be ensured by sufficiently and permanently reliably tensioned toothed belts 11 and 12.

The transmission members 6 to 10 are formed, in particular, as pinions, for example, from a dimensionally stable plastic material.

The toothed belts 11 and 12 may likewise be formed from a suitable plastic material which is not particularly compliant, and these belts are therefore subject to negligibly low levels of expansion and/or wear.

### LIST OF DESIGNATIONS

1 Pushing-out unit

2 Pushing-out lever

3 Accommodating depression

4 Housing

5 Electric motor

6 Transmission member

6a Toothing-formation portion

7 Transmission member

7a Toothing-formation portion of 7

7b Toothing-formation portion of 7

8 Transmission member

8a Toothing-formation portion of 8

8b Toothing-formation portion of 8

9 Transmission member

9a Toothing-formation portion of 9

9b Toothing-formation portion of 9

10 Transmission member

10a Toothing-formation portion of 10

10b Toothing-formation portion of 10

11 Toothed belt

12 Toothed belt

13 Printed circuit board

14 Belt-tensioning device

15 Resilient plate

16a Wall portion

16b Wall portion

We claim:

1. An apparatus for driving an actuating mechanism of an apparatus for at least one of opening and closing a furniture part accommodated in a movable manner on a basic furniture part, comprising a drive unit for driving the actuating mechanism via a transmission arrangement with a plurality of transmission members, at least one of which is a traction-mechanism device, the actuating mechanism being arranged on one of the furniture parts and temporarily contacting the other furniture part during at least one of opening and closing, wherein contact between the actuating mechanism and the other furniture part is broken during an opening operation.

2. The apparatus as claimed in claim 1, wherein the traction-mechanism device comprises at least one of a belt-drive device with a drive belt and a chain-drive device with a chain drive for transmitting rotary movement between two rotatable transmission members.

3. The apparatus as claimed in claim 2, wherein the drive belt of the belt-drive device transmits driving action between one transmission member, which is accommodated on a rotary shaft of the drive unit, and a further transmission member.

4. The apparatus as claimed in claim 2, wherein the belt-drive device comprises a plurality of drive belts.

5. The apparatus as claimed in claim 2, wherein the drive belt acts between any two of the plurality of transmission members.

6. The apparatus as claimed in claim 2, wherein the belt-drive device comprises two drive belts, wherein a first drive belt acts between a first transmission member and a second transmission member and a second drive belt acts between the second transmission member or a further transmission member and a third transmission member.

7. The apparatus as claimed in claim 2, further comprising a tensioning mechanism for setting the tensioning of the drive belt of the belt-drive device.

8. The apparatus as claimed in claim 7, wherein the tensioning mechanism comprises an adjusting arrangement for adjusting a position of the drive unit, wherein the drive unit is mounted in a movable manner.

9. The apparatus as claimed in claim 8, wherein the adjusting arrangement comprises a resilient mount for mounting the drive unit in a resilient manner.

10. The apparatus as claimed in claim 9, wherein the resilient mount comprises a resilient plate which is supported on fixed portions and on the movably mounted drive unit.

11. The apparatus as claimed in claim 9, wherein the resilient mount comprises a pin element with a resiliently disengageable pin portion in order to push the drive unit into a tensioning position, wherein the pin element can be set in its position relative to the movably mounted drive unit.

12. An opening apparatus comprising an apparatus as claimed in claim 1.

13. A piece of furniture comprising an opening apparatus as claimed in claim 12.
